(19) United States
(12) Patent Application Publication
(10) Pub. No.: US 2022/0281716 A1
(43) Pub. Date: Sep. 8, 2022

(54) ELEVATOR BRAKE PERFORMANCE DETECTION METHOD, DETECTION DEVICE AND ELEVATOR BRAKE

(71) Applicant: Otis Elevator Company, Farmington, CT (US)

(72) Inventor: Guosong Li, Tianjin (CN)

(21) Appl. No.: 17/525,148

(22) Filed: Nov. 12, 2021

(30) Foreign Application Priority Data
Mar. 8, 2021 (CN) 202110250997.6

(51) Int. Cl. B66B 5/00; B66B 1/32; B66B 1/34; B66B 5/18

(52) U.S. Cl. CPC B66B 5/0037; B66B 1/32; B66B 1/3446; B66B 5/18

(57) ABSTRACT

An elevator brake performance detection method includes controlling an input voltage or current of the electromagnetic member so that the elevator brake enters the braking state, and recording a corresponding current data trajectory of the electromagnetic member based on time characteristic; determining a first target point and a second target point in the current data trajectory according to the current data trajectory, the first target point and the second target point being a first peak point in the current data trajectory, and a start point at which the current value changes from decreasing to increasing in the current data trajectory, respectively; and calculating a time difference between the first target point and the second target point as a braking time of the elevator brake.

### FOREIGN PRIORITY

This application claims priority to Chinese Patent Application No. 202110250997.6, filed Mar. 8, 2021, and all the benefits accruing therefrom under 35 U.S.C. § 119, the contents of which in its entirety are herein incorporated by reference.

### TECHNICAL FIELD

The present disclosure relates to the technical field of elevators, in particular to an elevator brake performance detection method, an elevator brake performance detection device and an elevator brake.

### BACKGROUND

An elevator brake is a safety braking device in an elevator. It plays an important role in ensuring the safe operation of elevators and the personal safety of passengers. An existing elevator system 100 is shown in FIG. 1. Generally, an elevator power device 20 (such as a traction machine, etc.), an elevator brake 10 and other devices may be disposed in an elevator machine room 400, and the elevator power device 20 is connected with an elevator car 200 through a rope 300 so as to provide power to the elevator car 200 so that the elevator car 200 is driven to move up and down in an elevator hoistway, and to stop at the passenger's target floor by operating the elevator brake, such as Fa, Fb or Fc, etc., shown in FIG. 1. In addition, in the event of an elevator failure, emergency accident, etc., the elevator car can also be safely braked through the elevator brake.

Currently, many types of elevator brakes have been designed and provided. For example, in the example in FIG. 2, the elevator brake mainly includes a fixed part 1 and a moving part 2. The moving part 2 can move relative to the fixed part 1 according to operational needs, and guide members (such as a guide sleeve, a bolt, a pin, etc.) can be provided to guide a moving path of the moving part 2. The fixed part 1 can be fixedly installed in the elevator machine room 400, and a force F1 is provided by a component 5 (such as a spring, etc.) arranged between the fixed part 1 and the moving part 2 to drive the moving part 2 to move in a direction away from the fixed part 1, so that a friction member 4 located on the moving part 2 is enabled to contact a braking member 6 (such as a rotating wheel, a turntable, etc.) associated with the elevator power device 20 and that a braking force is provided, thereby making the elevator power device 20 stop outputting power to achieve the purpose of safe braking of the elevator car. In addition, an electromagnetic force F2 in an opposite direction to the force F1 may also be applied by means of an electromagnetic member 3 located at the fixed part 1 to urge the moving part 2 to move in a direction toward the fixed part 1, thereby disengaging the friction member 4 from the contact with the elevator power device 20, so that the power output of the elevator power device 20 is restored and the elevator car can operate again.

For example, in a repeated operational process described above, components in the elevator brake such as the guide sleeve, the bolt, the moving part and the like may wear, rust, crack or even completely fail, which will not only affect a working performance of the elevator brake, but also may bring safety risk problems, such as stuck-at failure, above-standard braking time, failure of braking force, etc., which will eventually cause injury to elevator passengers.

### SUMMARY

In view of the foregoing, the present disclosure provides an elevator brake performance detection method, an elevator brake performance detection device and an elevator brake, so as to solve or at least alleviate one or more of the above-mentioned problems and other problems in the prior art.

Firstly, according to an aspect of the present disclosure, an elevator brake performance detection method is provided, the elevator brake including an electromagnetic member for providing an electromagnetic force, and the elevator brake stopping an elevator car in a braking state by releasing the electromagnetic force and providing a braking force to an elevator power device, the elevator brake performance detection method including the following steps: A. controlling an input voltage or current of the electromagnetic member so that the elevator brake enters the braking state, and recording a corresponding current data trajectory of the electromagnetic member based on time characteristic; B. determining a first target point and a second target point in the current data trajectory according to the current data trajectory, the first target point and the second target point being a first peak point in the current data trajectory, and a start point at which the current value changes from decreasing to increasing in the current data trajectory, respectively; and C. calculating a time difference between the first target point and the second target point as a braking time of the elevator brake.

In the elevator brake performance detection method according to the present disclosure, optionally, the method further includes the following step: D. judging whether the braking time is larger than a preset value and whether an interval of the current data trajectory between the first target point and the second target point is smooth, so as to characterize braking smoothness of the elevator brake.

In the elevator brake performance detection method according to the present disclosure, optionally, when at least one peak or valley appears in said interval, it is judged that the interval is not smooth and the braking smoothness of the elevator brake is degraded.

In the elevator brake performance detection method according to the present disclosure, optionally, when the braking time is larger than the preset value and the interval is not smooth, it is judged that surface quality of a guide member in the elevator brake is degraded; the guide member is configured to guide a moving part in the elevator brake to move relative to a fixed part, the electromagnetic member is disposed on the fixed part, and in the braking state, the moving part is driven to move toward the elevator power device and contact the elevator power device through a friction member in the moving part to provide the braking force.

In the elevator brake performance detection method according to the present disclosure, optionally, an operating time of the elevator includes an idle period and a busy period, and steps A-D are automatically executed in the idle period with a preset time cycle.

In the elevator brake performance detection method according to the present disclosure, optionally, in step A, the input voltage of the electromagnetic member is controlled by gradually reducing a PWM duty cycle of the input voltage.

Optionally, the elevator brake performance detection method according to the present disclosure further includes the following steps: before step A is executed, confirming that the elevator car is currently in an empty state; and/or after step C is executed, outputting report information at least related to the braking time.

In the elevator brake performance detection method according to the present disclosure, optionally, the report information is stored locally in the elevator or stored in a cloud server, and/or the report information is sent to a user end which includes user's mobile communication terminal.

In addition, according to another aspect of the present disclosure, an elevator brake performance detection device is also provided, the elevator brake including an electromagnetic member for providing an electromagnetic force, and the elevator brake stopping an elevator car in a braking state by releasing the electromagnetic force and providing a braking force to an elevator power device, the elevator brake performance detection device including a controller which is configured to execute the following steps: A. controlling an input voltage or current of the electromagnetic member so that the elevator brake enters the braking state, and recording a corresponding current data trajectory of the electromagnetic member based on time characteristic; B. determining a first target point and a second target point in the current data trajectory according to the current data trajectory, the first target point and the second target point being a first peak point in the current data trajectory, and a start point at which the current value changes from decreasing to increasing in the current data trajectory, respectively; and C. calculating a time difference between the first target point and the second target point as a braking time of the elevator brake.

In the elevator brake performance detection device according to the present disclosure, optionally, the controller is further configured to execute the following step: D. judging whether the braking time is larger than a preset value and whether an interval of the current data trajectory between the first target point and the second target point is smooth, so as to characterize braking smoothness of the elevator brake.

In the elevator brake performance detection device according to the present disclosure, optionally, the controller is further configured to: when at least one peak or valley appears in said interval, judge that the interval is not smooth and the braking smoothness of the elevator brake is degraded.

In the elevator brake performance detection device according to the present disclosure, optionally, the controller is further configured to: when the braking time is larger than the preset value and the interval is not smooth, judge that surface quality of a guide member in the elevator brake is degraded; wherein the guide member is configured to guide a moving part in the elevator brake to move relative to a fixed part, the electromagnetic member is disposed on the fixed part, and in the braking state, the moving part is driven to move toward the elevator power device and contact the elevator power device through a friction member in the moving part to provide the braking force.

In the elevator brake performance detection device according to the present disclosure, optionally, an operating time of the elevator includes an idle period and a busy period, and the controller is further configured to execute steps A-D automatically in the idle period with a preset time cycle.

In the elevator brake performance detection device according to the present disclosure, optionally, the controller is configured to control the input voltage of the electromagnetic member by gradually reducing a PWM duty cycle of the input voltage.

In the elevator brake performance detection device according to the present disclosure, optionally, the controller is further configured to execute the following steps: before step A is executed, confirming that the elevator car is currently in an empty state; and/or after step C is executed, outputting report information at least related to the braking time.

In the elevator brake performance detection device according to the present disclosure, optionally, the controller is further configured to store the report information locally in the elevator or in a cloud server, and/or send the report information to a user end which includes user's mobile communication terminal.

In addition, according to further another aspect of the present disclosure, an elevator brake is also provided, which is equipped with the elevator brake performance detection device as described in any one of the above items.

From the following detailed description combined with the accompanying drawings, the principles, features, characteristics and advantages of the technical solutions according to the present disclosure will be clearly understood. For example, the application of the solutions of the present disclosure can automatically, efficiently and accurately evaluate the current operating characteristics of the elevator brake (such as braking time, stuck-at problem, etc.) at a low cost, thereby helping know about the system status in time, significantly reducing the cost of manual on-site check and maintenance, promoting the timely and accurate stocking up of elements and components, realizing a significant reduction in elevator maintenance expense and other expenses, reducing safety accidents, and effectively enhancing the safety and reliability of the elevator system. The present disclosure has obvious practicability and very high application value.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structural configurations described herein, and are not required to be drawn to scale.

FIG. 1 is a schematic structural view of an existing elevator system, in which an example of an elevator power device and an example of an elevator brake are shown at the same time.

FIG. 2 is a schematic view of a basic structure and working principle of an existing elevator brake.

FIG. 3 is a partial side structural view of the example of the elevator brake shown in FIG. 2.

FIG. 4 is a schematic flowchart of an embodiment of an elevator brake performance detection method according to the present disclosure.

FIG. 5 is a schematic flowchart of another embodiment of the elevator brake performance detection method according to the present disclosure.

FIG. 6 shows a comparison view of curves at the same time, which are obtained by detecting examples of two different elevator brakes using the embodiment of the elevator brake performance detection method according to the present disclosure, wherein a PWM duty cycle control curve of the corresponding electromagnetic member input voltage is also shown in the figure.

FIGS. 7 and 8 are respective graphs of the examples of the two different elevator brakes shown in FIG. 6.

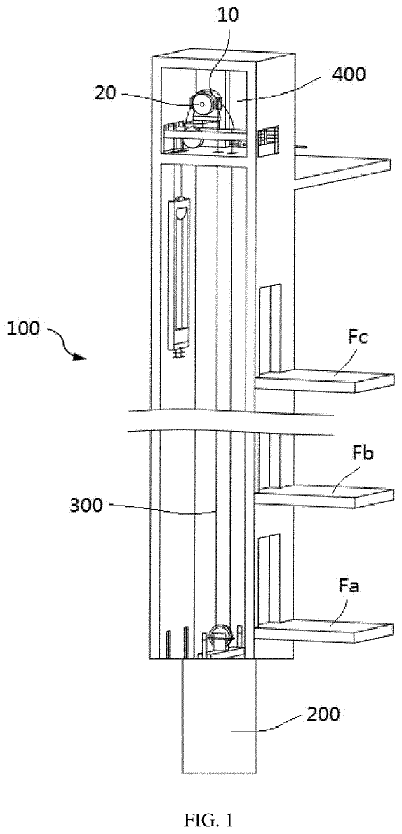

### DETAILED DESCRIPTION OF THE EMBODIMENT(S)

First, it should be noted that the steps, components, characteristics, advantages and the like of the elevator brake performance detection method, the elevator brake performance detection device and the elevator brake according to the present disclosure will be described below by way of example. However, it should be understood that neither of the descriptions should be understood as limiting the present disclosure in any way.

In addition, for any single technical feature described or implied in the embodiments mentioned herein or any single technical feature shown or implied in individual drawings, the present disclosure still allows for any combination or deletion of these technical features (or equivalents thereof) without any technical obstacle. Therefore, it should be considered that these more embodiments according to the present disclosure are also within the scope recorded in this document. In addition, for the sake of brevity, general items commonly known to those skilled in the art, such as the basic configurations and working principles of the elevator power device and the elevator brake will not be described in greater detail herein.

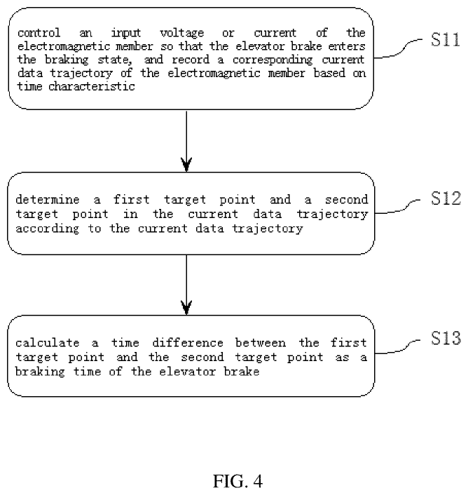

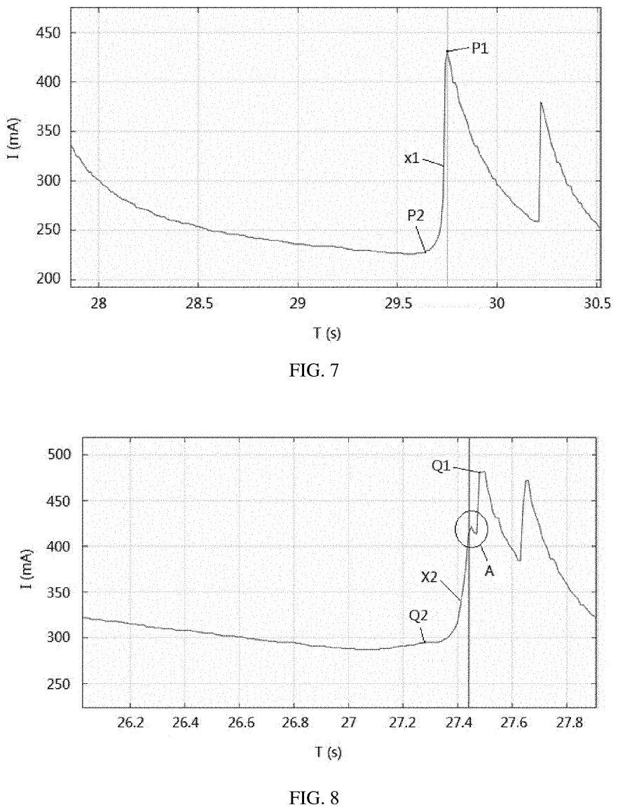

According to the design concept of the present disclosure, an elevator brake performance detection method is first provided, which can be used to detect and know about the performance of the elevator brake, such as a braking time of the elevator brake, braking smoothness, and operating conditions of elements and components in the elevator brake. Reference is made to FIG. 4, a processing flow of an embodiment of the method according to the present disclosure is exemplarily shown, which may specifically include the following steps: First, in step S11, the elevator brake may be controlled to enter a braking state (also often referred to as a “brake drop state”, etc.). Specifically, by controlling a voltage or current of an electromagnetic member that is delivered to the elevator brake, for example, by gradually reducing the voltage or current, etc., the elevator brake can be brought into the braking state, and at the same time, a current data trajectory of the electromagnetic member in the process is recorded. Such a current data trajectory will have a time characteristic, that is, it can express a changing process of an operating current I of the electromagnetic member with time T in the braking process of the elevator brake, which is for example exemplarily illustrated through curves X shown in FIG. 7 and FIG. 8 respectively. For the above-mentioned data such the voltage and current of the electromagnetic member, it can be obtained in many ways. For example, as operational data of elevator devices, it may be directly obtained from the existing elevator brakes, separate detection devices (such as voltage sensors, current sensors, etc.), or control units, modules, devices or an operation management system in the elevator system.

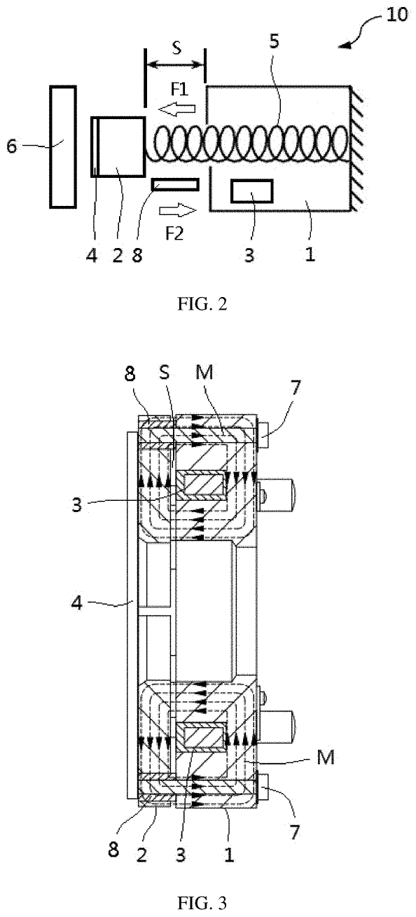

In the above step, various feasible ways can be used to control and operate the electromagnetic member. By way of example, an output electromagnetic force of the electromagnetic member may be controlled by gradually reducing the duty cycle of PWM (Pulse Width Modulation, sinusoidal wave pulse width modulation) of the input voltage of the electromagnetic member (refer to curve Y shown at the same time in FIG. 7) or using any other appropriate control method. With reference to the examples of FIGS. 2 and 3, an electromagnetic field M can be formed by controlling the input voltage of the electromagnetic member 3 in the elevator brake, and an electromagnetic force F2 can be output. The electromagnetic force F2 has an opposite direction to a force F1 applied to a moving part 2 by a component 5. Once the electromagnetic force F2 is released (for example, the electromagnetic member 3 is in a de-energized state), then under the push of the force F1, the moving part 2 will move toward a braking member 6 along a guiding direction of guide members such as a component 7 (e.g., a bolt, a pin, etc.), a guide sleeve 8, so that a friction member 4 and the braking member 6 are in contact; then a braking force can be applied to the braking member 6, thereby prompting the elevator power device to enter the braking state and stop outputting power outwardly, which can make the elevator car stop.

It should be noted that for the electromagnetic member, the present disclosure allows for flexible setting and selections thereof according to actual application requirements in terms of the specific structure, configuration, components, arrangement position and installation method in the elevator brake, etc.; that is, there are no specific restrictions on this. As an exemplary illustration, for example, in some embodiments, one or more winding coils may be selected very conveniently and arranged in a circumferential direction of the fixed part. For example, four or six winding coils may be evenly arranged in the circumferential direction of the fixed part at the same time, which not only helps promote outwardly providing and applying the electromagnetic force more evenly, but also provides a certain degree of redundancy at the same time, thereby improving the safety and reliability of the elevator brake.

In addition, as for the input variable of the control operation of the electromagnetic member, it can be realized in various ways, such as by providing a corresponding PWM control module in a control part (such as an elevator frequency converter or an additional control circuit board and other software and hardware) for controlling the operation of the elevator brake in the elevator brake or in the elevator system, or by adding a circuit board with a PWM control function, etc., so that any suitable control method such as the above-mentioned PWM duty cycle of the input voltage can be very conveniently realized.

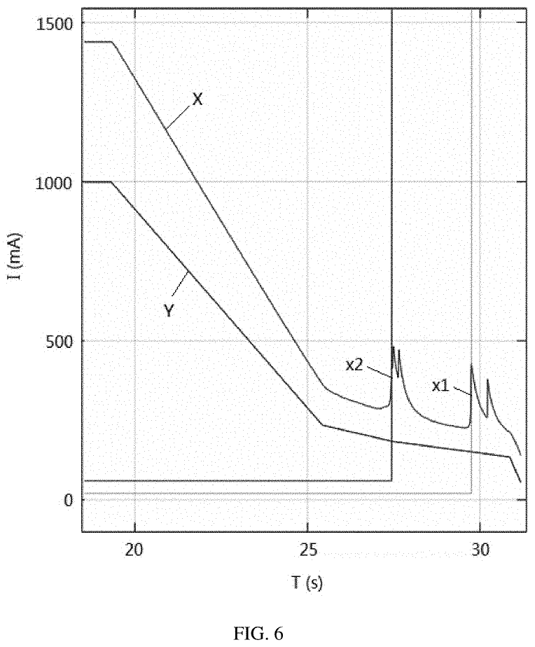

Next, reference is made to FIGS. 4 and 6-8, in step S12, a first target point and a second target point in the current data trajectory can be determined from the current data trajectory obtained in step S11, which represent a first peak point (for example, peak point P1 in FIG. 7 and peak point Q1 in FIG. 8) in the current data trajectory, and a start point at which the current value changes from decreasing to increasing in the current data trajectory (for example, start point P2 in FIG. 7 and start point Q2 in FIG. 8), respectively. According to the above characteristics of the first target point and the second target point, they can be very easily identified from the current value points contained in the current data trajectory such as by data algorithm processing.

Then, a time difference between the above two target points in the current data trajectory can be calculated in step S13, that is, a difference in time between the first target point and the second target point. Since such time difference data can more accurately reflect the actual time consumed by the elevator brake to complete the braking operation, it can be used as the braking time of the elevator brake (also often referred to as “brake drop time”, etc.). This definition can be theoretically supported by Lenz's law in electromagnetics. As one of the basic performance parameters, the braking time obtained above can more accurately reflect the current working performance of the elevator brake, and the braking time can be further provided to various applications in the elevator system or other systems for use.

As compared with the solutions of the present disclosure, since the detection point of a brake switch is usually arranged in a middle position of an air gap S between the fixed part and the moving part in the existing elevator brakes, using the signal of the brake switch as a basis for determining the brake drop time in some prior art is not accurate enough, which will cause a deviation from the actual braking time, and thus may bring undesired adverse effects.

Taking the situations shown in FIG. 7 and FIG. 8 as an example, the exemplary description is continued below. In FIG. 7, the respective coordinates of the peak point P1 and the start point P2 in the coordinate system in the figure (the horizontal coordinate represents the time T in seconds, and the longitudinal coordinate represents the current I in milliamps, which also applies to FIG. 8) are (29.75, 431) and (29.64, 228) respectively, then the braking time of the elevator brake is 29.75−29.64=0.11 second. In FIG. 8, the respective coordinates of the peak point Q1 and the start point Q2 in the coordinate system in the figure are (27.48, 481) and (27.28, 295) respectively, then the braking time of the elevator brake is 27.48−27.28=0.20 seconds. Through the above processing, it can be found that if according to a set standard (for example, the braking time is required to be less than 0.15 seconds), the elevator brake corresponding to FIG. 7 currently has good performance, and the elevator brake corresponding to FIG. 8 cannot meet the standard, then it is necessary to take timely measures on the latter to solve the above problem.

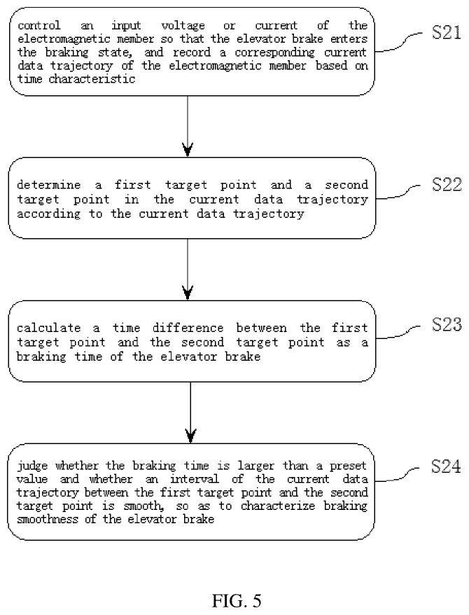

Referring to FIG. 5 again, a general processing flow of another embodiment of the elevator brake performance detection method according to the present disclosure is given in this figure. Herein, unless otherwise specified, for steps S21-S23 in FIG. 5 that are the same as or similar to those in FIG. 4, direct reference may be made to the corresponding descriptions of steps S11-S13 in the example of FIG. 4 above.

FIG. 5 also shows step S24. Specifically, in this embodiment of the elevator brake performance detection method, it can be further judged whether the braking time obtained in step S23 is larger than a preset value (which may be set or adjusted according to actual application requirements, such as 0.15 seconds, 0.16 seconds, 0.18 seconds, etc.), and whether the interval between the first target point and the second target point (such as the interval X1 in FIG. 7 and the interval X2 in FIG. 8) in the current data trajectory recorded in step S21 is smooth, so as to characterize the braking smoothness of the elevator brake (or referred to as “brake drop smoothness”, etc.), which can reflect the current working performance of the elevator brake.

As an example, it can be found by comparison that the interval X1 in the example in FIG. 7 is very smooth as a whole, while the interval X2 in FIG. 8 has obvious undulations, i.e., a portion marked by reference sign A in FIG. 8, in which discontinuous abnormal shapes such as sharp peaks or sharp valleys appear, causing the interval X2 to be unsmooth. In this way, it can be determined that the elevator brake corresponding to FIG. 8 has experienced a degradation in the braking smoothness, which can be caused by various reasons. For example, elements and components in the elevator brake (such as the guide sleeve, the bolt, and the moving part in contact with the guide sleeve) may have rusted, worn, cracked, corroded, failed, etc., which will eventually adversely affect the working performance of the elevator brake, posing safety hazards or risks. For example, the above-mentioned unsmoothness found through detection may be caused by the degradation of surface quality of the guide members such as the guide sleeve in the elevator brake during use (such as rusting, partial damage, cracking, etc.), which may cause problems such as braking delay or stuck-at failure.

The application of the method of the present disclosure can preventively find the above problems in time, and there is no need arrange personnel to go to the elevator brake site for detection operation, thereby helping quickly and efficiently take countermeasures and promoting timely and accurate stocking-up, maintenance, updates and replacement of elements and components, which can effectively reduce elevator maintenance costs and other expenses, and significantly enhance the safety performance and management service level of the elevator system.

In addition, it can be understood that for a specific type of elevator brake product, since its basic configuration, components, overall condition, advantages and disadvantages, etc., are relatively familiar to technicians, after the method of the present disclosure is applied, once it is found that the braking smoothness of the elevator brake product has decreased, technicians can identify the specific elements or components of the elevator brake product quickly, so that such problems can be solved quickly, thus effectively avoiding subsequent undesired device failure or safety accident.

It should be understood that the above embodiments are only exemplary description. Without departing from the spirit of the present disclosure, the method of the present disclosure allows more possible settings, changes and adjustments to be made according to different application requirements, to which there will be no restrictions at all.

For example, as an optional situation, a step of confirming whether the elevator car is currently in an empty state may be further added before the above step S11 (or S21), that is, only after it is determined that the elevator car is suitable for the detection operation, will steps S11-S13 (or S21-S24) be executed, which helps enhance the safety of the entire detection operation.

For another example, as an optional situation, after step S13 (or S24) is executed, report information related the obtained performances of the elevator brake (such as the braking time, braking smoothness, surface quality of the guide member, etc.) may be output outwardly; for example, such report information can be stored locally in the elevator or stored in a cloud server, so that elevator operation management personnel, equipment maintenance personnel, equipment manufacturers or parts suppliers can be informed in time. It can be understood that those skilled in the art can make flexible settings on the specific content, expression form, transmission path, level, etc., of the report information according to actual requirements.

For example, in some applications, the report information may be sent to the user end (such as a mobile phone, a PAD and other mobile communication terminals) in the form of text prompts, voice reminders, etc., so as to enable the user to grasp the working performance condition of the elevator brake in time. Therefore, preventive measures such as arranging personnel to replace parts (such as the guide sleeve) and purchasing spare parts in advance ensure that the elevator system can operate safely and reliably for a long time. For another example, in some applications, multiple safety measures may be used individually or in combination; for example, the elevator may be controlled to stop running, and the report information may be sent to the user end, etc., so as to achieve the effects of safety precautions and timely warning.

In addition, it should also be pointed out that the method of the present disclosure may be implemented as required; it may be performed in a one-time manner at any suitable time point, or may be implemented automatically with a preset time cycle (such as once every five days, once a week, once every two weeks, etc.). For example, as an alternative solution, the operating time of the elevator may be divided into a busy period (such as daytime working periods on working days) and an idle period (such as midnight periods on working days (such as 00:00-3:00, 01:00-2:00, etc.), or midnight periods on only non-working days), and then the method of the present disclosure is automatically performed only in the above idle period with a preset time cycle, so as to automatically track and grasp the performance condition of the elevator brake during the whole process, which will not cause any adverse effect on the normal operation and use of the elevator.

As another aspect that is significantly superior to the prior art, the present disclosure also provides an elevator brake performance detection device, which is provided with a controller for executing various possible steps of the method according to the present disclosure including, for example, the content discussed above. The elevator brake performance detection device can be manufactured and sold separately.

It can be understood that according to the disclosure of the present application, those skilled in the art may use, for example, processors, electronic circuits, integrated circuits (ASICs) and/or memories and combinational logic circuits for executing one or more software or firmware programs, and any other suitable element and component to realize the above-mentioned controller in the elevator brake performance detection device. In addition, since the technical contents of various specific steps, implementations and usage conditions of the elevator brake, the input voltage, input current and current data trajectory processing of the electromagnetic member have been described in great detail in the above, reference may be directly made to specific description of the corresponding parts mentioned above, which will not be repeated herein.

In addition, according to the technical solutions of the present disclosure, an elevator brake is also provided. Specifically, the elevator brake may be equipped with the elevator brake performance detection device designed and provided according to the present disclosure, which can automatically, conveniently, efficiently and accurately detect the current working performance condition of the elevator brake, and significantly reduce elevator maintenance cost, so as to achieve these significant technical advantages as mentioned above. Therefore, the present disclosure has very high practical value and creates considerable economic benefits.

The elevator brake performance detection method, the elevator brake performance detection device and the elevator brake according to the present disclosure have been elaborated above in detail by way of example only. These examples are merely used to illustrate the principles and embodiments of the present disclosure, rather than limiting the present disclosure. Various modifications and improvements can be made by those skilled in the art without departing from the spirit and scope of the present disclosure. Therefore, all equivalent technical solutions should fall within the scope of the present disclosure and be defined by the claims of the present disclosure.

What is claimed is:

1. An elevator brake performance detection method, the elevator brake comprising an electromagnetic member for providing an electromagnetic force, and the elevator brake stopping an elevator car in a braking state by releasing the electromagnetic force and providing a braking force to an elevator power device, wherein the elevator brake performance detection method comprises:
A. controlling an input voltage or current of the electromagnetic member so that the elevator brake enters the braking state, and recording a corresponding current data trajectory of the electromagnetic member based on time characteristic;
B. determining a first target point and a second target point in the current data trajectory according to the current data trajectory, the first target point and the second target point being a first peak point in the current data trajectory, and a start point at which the current value changes from decreasing to increasing in the current data trajectory, respectively; and
C. calculating a time difference between the first target point and the second target point as a braking time of the elevator brake.

2. The elevator brake performance detection method according to claim 1, further comprising:
D. judging whether the braking time is larger than a preset value and whether an interval of the current data trajectory between the first target point and the second target point is smooth, so as to characterize braking smoothness of the elevator brake.

3. The elevator brake performance detection method according to claim 2, wherein when at least one peak or valley appears in said interval, it is judged that the interval is not smooth and the braking smoothness of the elevator brake is degraded.

4. The elevator brake performance detection method according to claim 2, wherein when the braking time is larger than the preset value and the interval is not smooth, it is judged that surface quality of a guide member in the elevator brake is degraded; the guide member is configured to guide a moving part in the elevator brake to move relative to a fixed part, the electromagnetic member is disposed on the fixed part, and in the braking state, the moving part is driven to move toward the elevator power device and contact the elevator power device through a friction member in the moving part to provide the braking force.

5. The elevator brake performance detection method according to claim 2, wherein an operating time of the elevator comprises an idle period and a busy period, and wherein A-D are automatically executed in the idle period with a preset time cycle.

6. The elevator brake performance detection method according to claim 1, wherein in A, the input voltage of the electromagnetic member is controlled by gradually reducing a PWM duty cycle of the input voltage.

7. The elevator brake performance detection method according to claim 1, further comprising:
before A is executed, confirming that the elevator car is currently in an empty state; and/or
after C is executed, outputting report information at least related to the braking time.

8. The elevator brake performance detection method according to claim 7, wherein the report information is stored locally in the elevator or stored in a cloud server, and/or the report information is sent to a user end which comprises user's mobile communication terminal.

9. An elevator brake performance detection device, the elevator brake comprising an electromagnetic member for providing an electromagnetic force, and the elevator brake stopping an elevator car in a braking state by releasing the electromagnetic force and providing a braking force to an elevator power device, wherein the elevator brake performance detection device comprises a controller which is configured to execute the following:
A. controlling an input voltage or current of the electromagnetic member so that the elevator brake enters the braking state, and recording a corresponding current data trajectory of the electromagnetic member based on time characteristic;
B. determining a first target point and a second target point in the current data trajectory according to the current data trajectory, the first target point and the second target point being a first peak point in the current data trajectory, and a start point at which the current value changes from decreasing to increasing in the current data trajectory, respectively; and
C. calculating a time difference between the first target point and the second target point as a braking time of the elevator brake.

10. The elevator brake performance detection device according to claim 1, wherein the controller is further configured to execute the following:
D. judging whether the braking time is larger than a preset value and whether an interval of the current data trajectory between the first target point and the second target point is smooth, so as to characterize braking smoothness of the elevator brake.

11. The elevator brake performance detection device according to claim 10, wherein the controller is further configured to: when at least one peak or valley appears in said interval, judge that the interval is not smooth and the braking smoothness of the elevator brake is degraded.

12. The elevator brake performance detection device according to claim 10, wherein the controller is further configured to: when the braking time is larger than the preset value and the interval is not smooth, judge that surface quality of a guide member in the elevator brake is degraded; wherein the guide member is configured to guide a moving part in the elevator brake to move relative to a fixed part, the electromagnetic member is disposed on the fixed part, and in the braking state, the moving part is driven to move toward the elevator power device and contact the elevator power device through a friction member in the moving part to provide the braking force.

13. The elevator brake performance detection device according to claim 10, wherein an operating time of the elevator comprises an idle period and a busy period, and the controller is further configured to execute A-D automatically in the idle period with a preset time cycle.

14. The elevator brake performance detection device according to claim 9, wherein the controller is configured to control the input voltage of the electromagnetic member by gradually reducing a PWM duty cycle of the input voltage.

15. The elevator brake performance detection device according to claim 9, wherein the controller is further configured to execute the following:
before A is executed, confirming that the elevator car is currently in an empty state; and/or
after C is executed, outputting report information at least related to the braking time.

16. The elevator brake performance detection device according to claim 15, wherein the controller is further configured to store the report information locally in the elevator or in a cloud server, and/or send the report information to a user end which comprises user's mobile communication terminal.

17. An elevator brake, which is equipped with the elevator brake performance detection device according to claim 9.
